(19) United States
(12) Patent Application Publication
(10) Pub. No.: US 2023/0258029 A1
(43) Pub. Date: Aug. 17, 2023

(54) FLUSH DOOR HANDLE WITH MOVABLE SHUTTER

(71) Applicant: INTEVA PRODUCTS, LLC, Troy, MI (US)

(72) Inventors: Pascal Philippe, Orléans (FR); Yoshihiko Tametani, Tokyo (JP); Jean-Marc Belmond, Saint-Jean Le Blanc (FR)

(21) Appl. No.: 18/108,252

(22) Filed: Feb. 10, 2023

(30) Foreign Application Priority Data
Feb. 11, 2022 (FR) 22/01235

(51) Int. Cl. E05B 85/10; E05B 81/04; E05B 81/76; E05B 81/90; E05B 83/36; E05B 77/02; B60R 25/01; B60R 25/10

(52) U.S. Cl. CPC E05B 85/103; E05B 81/04; E05B 81/77; E05B 81/90; E05B 83/36; E05B 77/02; B60R 25/01; B60R 25/10

(57) ABSTRACT

A door handle assembly for a vehicle door, including: a housing; a door moveably secured to the housing for movement between a closed position and an open position, the door providing access to an interior cavity of the housing when the door is in the open position, wherein the door moves inwardly and upwardly into the housing in order to transition from the closed position to the open position, the interior cavity being inaccessible and covered by the door when the door is in the closed position.

### CROSS REFERENCE TO RELATED APPLICATIONS

This application claims priority under 35 U.S.C. § 119 to the following French Patent Application No. FR 22/01235, filed on Feb. 11, 2022, the entire contents of which are incorporated herein by reference thereto.

### BACKGROUND

Exemplary embodiments of the present disclosure pertain to the art of vehicle door handles.

### BACKGROUND

Some vehicles are equipped with flush door handles however and in all instances, the handle must move outwardly from the vehicle door before it can be grabbed by the end user. Once moved out, the flush door handle is pulled further outward by the user in order to release the latch of the vehicle door.

As a consequence and in some conditions the user needs to wait for the flush door handle to move out before they can grab it and then release the latch of the vehicle door.

In the event of an accident and in order to prevent the vehicle door latch from releasing during a crash, flush door handles are equipped with balancing features, especially when a mechanical door latch release is needed (either for normal mode of for back up mode). During crash or accident, flush door handles are kept in flush position in order to prevent them from being damaged.

Accordingly, it is desirable to provide an improved flush door handle.

### BRIEF DESCRIPTION

Disclosed is a door handle assembly for a vehicle door, including: a housing; a door moveably secured to the housing for movement between a closed position and an open position, the door providing access to an interior cavity of the housing when the door is in the open position, wherein the door moves inwardly and upwardly into the housing in order to transition from the closed position to the open position, the interior cavity being inaccessible and covered by the door when the door is in the closed position.

In addition to one or more of the features described above, or as an alternative to any of the foregoing embodiments, the door is operatively coupled to a door lever, the door lever being pivotally secured to a portion of the housing and has a protrusion slidably received within an elongated opening of the door.

In addition to one or more of the features described above, or as an alternative to any of the foregoing embodiments, the door lever has a plurality of teeth that meshingly engage a gear train that is operably coupled to a gear that is driven by a motor.

In addition to one or more of the features described above, or as an alternative to any of the foregoing embodiments, the door has a pair of protrusions that are slidably received in elongated slots of the housing as the door moves from the closed position to the open position and vice versa.

In addition to one or more of the features described above, or as an alternative to any of the foregoing embodiments, further including a sensor located within the interior cavity, the sensor being operably coupled to a latch such that upon activation of the sensor the latch is opened.

In addition to one or more of the features described above, or as an alternative to any of the foregoing embodiments, the latch is an electronic latch associated with the vehicle door.

In addition to one or more of the features described above, or as an alternative to any of the foregoing embodiments, wherein the sensor is a capacitive sensor.

In addition to one or more of the features described above, or as an alternative to any of the foregoing embodiments, further including a motor for moving the door between the closed position and the open position, the motor being activated when a shutter activation and unlock switch of the door handle assembly is actuated through contact of a portion of the door when it is pivoted inwardly into the housing.

In addition to one or more of the features described above, or as an alternative to any of the foregoing embodiments, the housing is angled inwardly with respect to an outer shell of the vehicle door.

In addition to one or more of the features described above, or as an alternative to any of the foregoing embodiments, further including a lock switch which when actuated locks the vehicle.

In addition to one or more of the features described above, or as an alternative to any of the foregoing embodiments, the lock switch is a capacitive sensor or any other switch technology.

In addition to one or more of the features described above, or as an alternative to any of the foregoing embodiments, further including a mechanical release located in the interior cavity, the mechanical release operatively coupled to a latch via linkage such that once the mechanical release is actuated the latch is opened.

In addition to one or more of the features described above, or as an alternative to any of the foregoing embodiments, the vehicle door handle assembly is operably coupled to sensors of a vehicle which are used for determining whether a crash is about to occur.

In addition to one or more of the features described above, or as an alternative to any of the foregoing embodiments, the sensors provide a signal to a microcontroller of the vehicle door handle assembly.

Also disclosed is a method for operating a door handle assembly of a vehicle door, including: moveably mounting a door to a housing of the door handle assembly, the door capable of movement between a closed position and an open position, the door providing access to an interior cavity of the housing when the door is in the open position, wherein the door moves inwardly and upwardly into the housing in order to transition from the closed position to the open position, the interior cavity being inaccessible and covered by the door when the door is in the closed position.

In addition to one or more of the features described above, or as an alternative to any of the foregoing embodiments, the door is operatively coupled to a door lever, the door lever being pivotally secured to a portion of the housing and has a protrusion slidably received within an elongated opening of the door.

In addition to one or more of the features described above, or as an alternative to any of the foregoing embodiments, the door lever has a plurality of teeth that meshingly engage a gear train that is operably coupled to a gear that is driven by a motor.

In addition to one or more of the features described above, or as an alternative to any of the foregoing embodiments, the door has a pair of protrusions that are slidably received in elongated slots of the housing as the door moves from the closed position to the open position and vice versa.

In addition to one or more of the features described above, or as an alternative to any of the foregoing embodiments, further including a sensor located within the interior cavity, the sensor being operably coupled to a latch such that upon activation of the sensor the latch is opened.

In addition to one or more of the features described above, or as an alternative to any of the foregoing embodiments, the latch is an electronic latch associated with the vehicle door.

### BRIEF DESCRIPTION OF THE DRAWINGS

The following descriptions should not be considered limiting in any way. With reference to the accompanying drawings, like elements are numbered alike:

FIG. 1 is a portion of a vehicle door with a door handle assembly in a closed state in accordance with the present disclosure;

FIG. 2 is a portion of a vehicle door with a door handle assembly in an open state in accordance with the present disclosure;

FIG. 3A is a perspective view of a vehicle door handle assembly in a closed state in accordance with the present disclosure;

FIG. 3B is a perspective view of a vehicle door handle assembly in a open state in accordance with the present disclosure;

FIG. 4 is a side view of a vehicle door handle assembly in a closed state in accordance with the present disclosure;

FIG. 5 is a schematic illustration of a portion of the vehicle door handle assembly in accordance with the present disclosure;

FIG. 6A is a side view of a vehicle door handle assembly in a closed state in accordance with the present disclosure;

FIG. 6B is a side view of a vehicle door handle assembly as it begins to be moved from the closed state to an open state in accordance with the present disclosure;

FIG. 6C is a side view of a vehicle door handle assembly in an open state in accordance with the present disclosure;

FIG. 7A is a side view of a vehicle door handle assembly in a closed state in accordance with the present disclosure;

FIG. 7B is a side view of a vehicle door handle assembly as it begins to be moved from the closed state to an open state in accordance with the present disclosure;

FIG. 7C is a side view of a vehicle door handle assembly in an open state in accordance with the present disclosure;

FIG. 7D is a side view of a vehicle door handle assembly in an open state where a user is activating a release sensor of the vehicle door handle assembly in accordance with the present disclosure;

FIG. 8A is a side view of a vehicle door handle assembly being manually pushed into an open state in accordance with the present disclosure;

FIG. 8B is a side view of a vehicle door handle assembly in an open state wherein an ID recognition is presented to unlock the vehicle door;

FIG. 8C is a side view of a vehicle door handle assembly in an open state giving access to mechanical backup emergency release in accordance with the present disclosure;

FIG. 9A is a side view of a vehicle door handle assembly being manually pushed into an open state in accordance with the present disclosure;

FIG. 9B is a side view of a vehicle door handle assembly in an open state wherein an ID recognition is presented to unlock the vehicle door; and

FIG. 9C is a side view of a vehicle door handle assembly in an open state giving access to mechanical backup emergency release in accordance with the present disclosure.

### DETAILED DESCRIPTION

A detailed description of one or more embodiments of the disclosed apparatus and method are presented herein by way of exemplification and not limitation with reference to the Figures.

The present disclosure is directed to a flush door handle for a vehicle that does not move outside of the vehicle door outer door panel but moves inside the door shell of the vehicle door. By design, this handle requires the same movement of the hand for the user to first push the shutter (or the handle flap) before to touch sensors to release the door. The shape of the handle is made in such a way that once the door is released, the user has just to pull on it from the touch area to get the door opened.

The flush door handle of the present disclosure is designed to work with an e-latch (latch with electrical release), having in one embodiment a mechanical back up release mode.

In a normal operating mode and depending upon the vehicle settings, the shutter (or the flap) of the door flush handle can move automatically inside the door shell for users having a key fob or any other equivalent ID with them (e.g., detection provided by a passive entry system). Otherwise, the shutter (or the flap) can be pushed by any user to trigger the handle shutter movement first and then touch the sensor while grabbing the door to release and then open it. In this operation the door must be unlocked.

In addition and during normal use, the flap is used to hide the back-up interface to release the e-latch mechanically.

During a crash, the shutter (or the flap) can be moved inside the door shell as soon as emergency signals such as urgent braking becoming available on a network of the vehicle. As the handle is moving inside the door shell, it will not be damaged at any time. After the crash, the back-up interface is immediately available to recue people to release the door mechanically from outside.

For main car battery failure mode, the shutter (or the flap) can be pushed by hand inside the door shell for the user to get access to the back-up interface and release the latch mechanically (once the mechanical back-up has been engaged by the system).

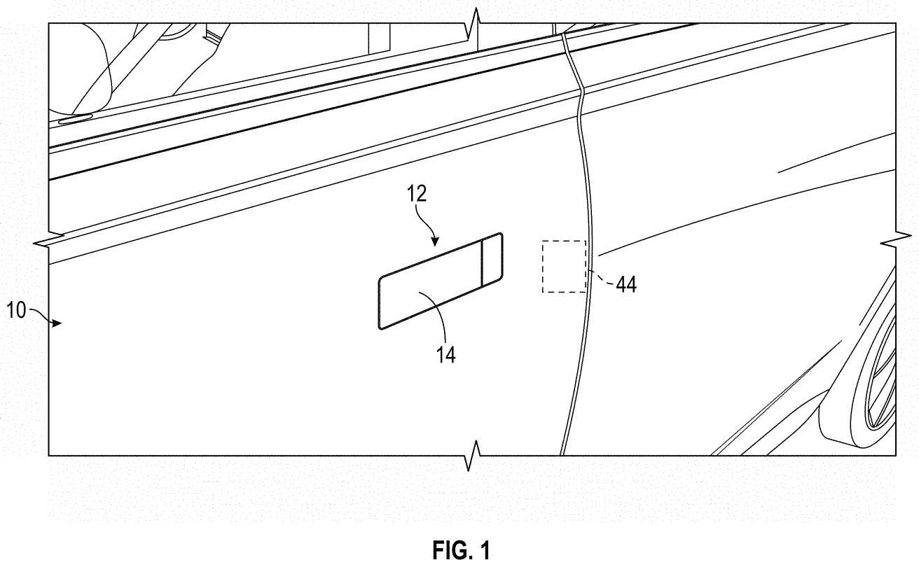

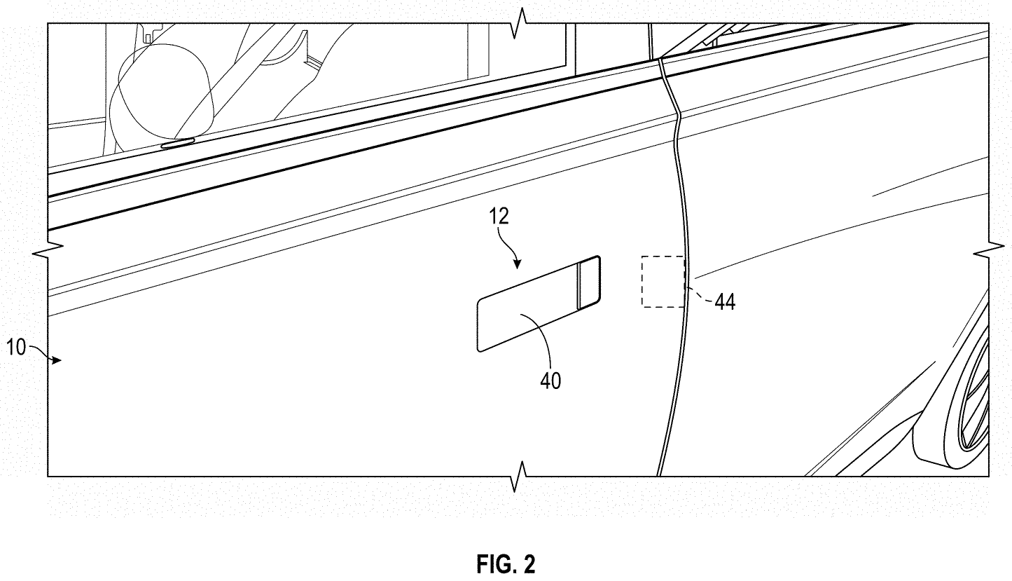

Referring now to the FIGS, FIG. 1 is a portion of a vehicle door 10 with a door handle assembly 12 in a closed state in accordance with the present disclosure. FIG. 2 is a portion of a vehicle door 10 with the door handle assembly 12 in an open state in accordance with the present disclosure.

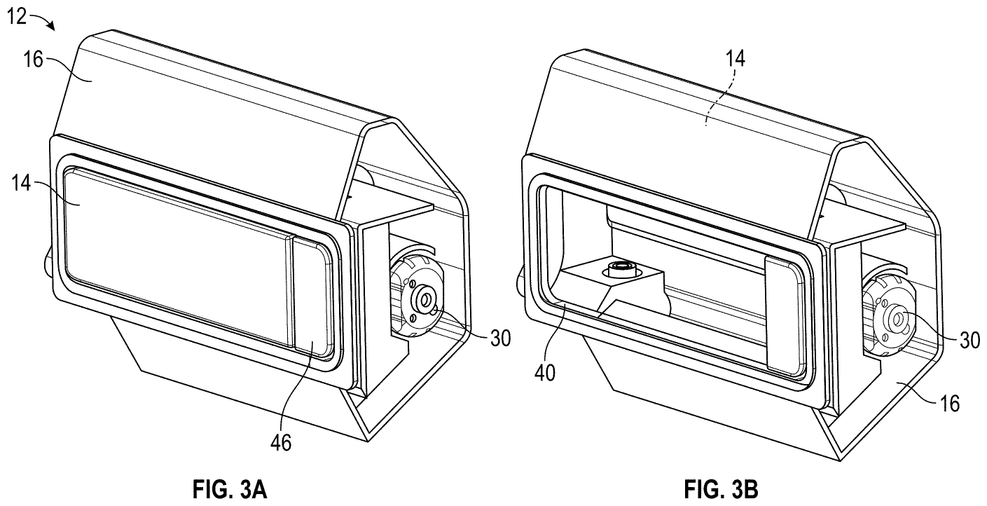

FIG. 3A is a perspective view of the vehicle door handle assembly 12 in a closed state in accordance with the present disclosure. The vehicle door handle assembly 12 has a shutter or door 14 moveably secured to a housing 16 of the vehicle door handle assembly 12.

Referring now to at least FIGS. 1-8C, the shutter or door 14 is operatively coupled to a door lever 18. The door lever 18 is pivotally secured to a portion of the housing 16 and has a protrusion 20 slidably received within an elongated opening 22 of the shutter or door 14 such that slidable movement of the shutter or door with respect to the housing 16 is possible. The door lever 18 has a plurality of teeth 24 that meshingly engage a gear train 26 that is operably coupled to a gear 28 that is driven by a motor 30. The shutter or door 14 has a pair of protrusions 32 that are slidably received in elongated slots 34 of the housing 16 as the shutter or door 14 moves upwardly and from the closed position to the open position and vice versa.

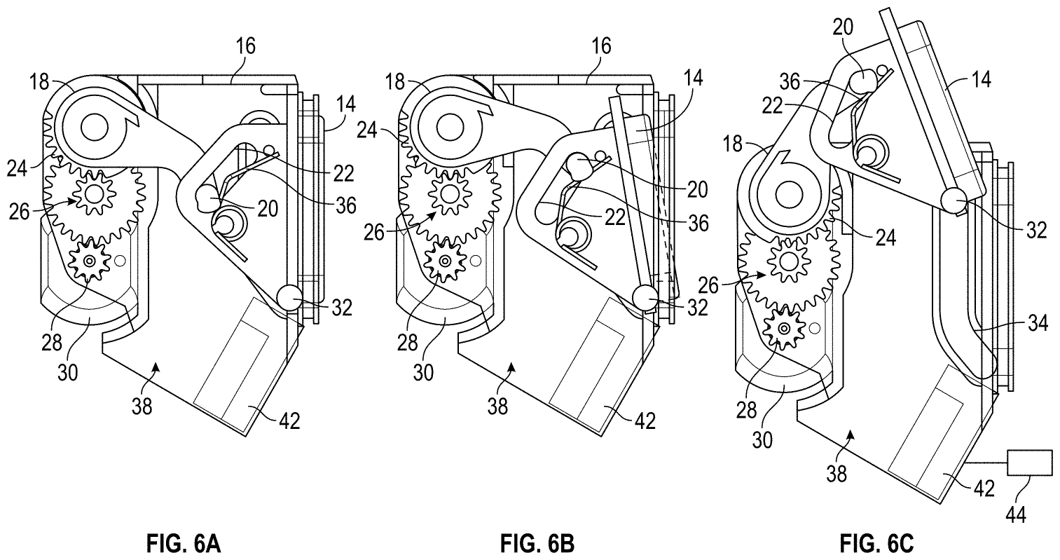

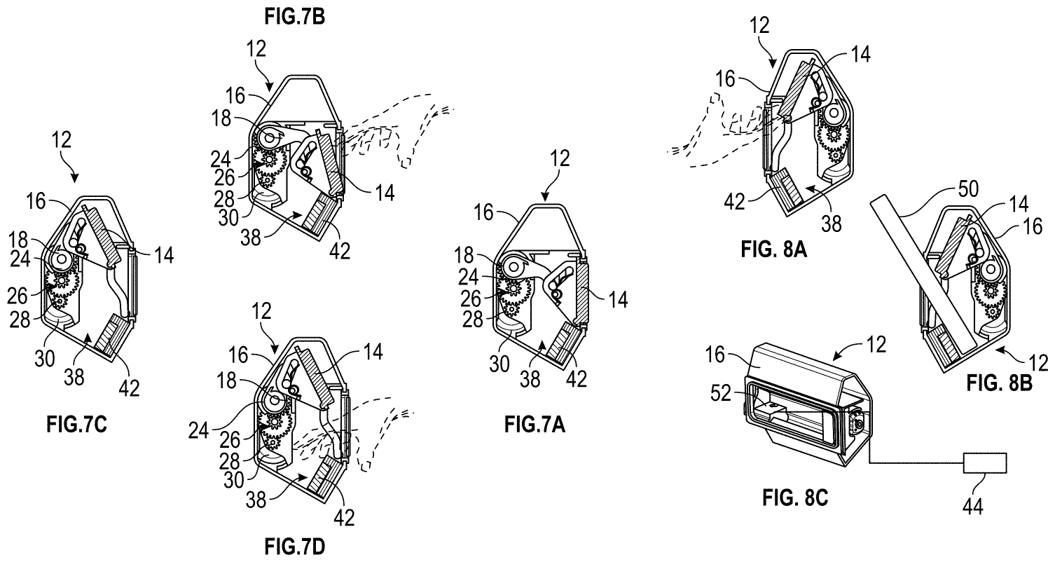

During one mode of operation and when a user applies a force to the shutter or door 14 such that the shutter or door 14 pivots inwardly into the housing 16 (FIGS. 6B and 7B) the protrusion slides over a biasing spring 36 such that the protrusion moves upwardly in the elongated opening 22. As used herein, upwardly refers to moving in an upward direction with respect to the housing 16 when the housing 16 is secured to a vehicle door 10. Thereafter and once the shutter or door 14 is in this position, the motor 30 is actuated and the door lever 18 rotates in the position illustrated in at least FIGS. 6C and 7C. This rotation of door lever 18 causes the shutter or door 14 to move upwardly from the position illustrated in FIGS. 6A and 6B to FIG. 6C. In one embodiment, the motor 30 is activated when a shutter activation switch 37 is actuated through contact of a portion of the shutter or door 14 when it is pivoted inwardly into the housing as illustrated in at least FIGS. 6B and 7B. This, of course, can only occur once the door handle assembly 12 is unlocked. For example and in a normal mode, when a key is detected (e.g., key fob or mobile device with an appropriate authentication) the door handle assembly 12 is unlocked either automatically or through contact with a lock/unlock interface portion of the door handle assembly 12.

Once the shutter or door 14 is in the position illustrated in at least FIGS. 2, 6C and 7C, an interior cavity 38 of the housing 16 is accessible via an opening 40 in the housing. At this point a user can insert their hand into the cavity 38 and touch a sensor 42. Sensor 42 is operably coupled to an electronic latch 44 such that upon touching the sensor 42 the electronic latch 44 is activated and the door 10 can be opened by pulling on an edge of opening 40. Thereafter, the door 10 can be closed and the electronic latch 44 will secure the door 10 and the shutter or door 14 is then returned to the closed position illustrated in at least FIGS. 1, 6A and 7A through activation of the motor 30, gear train 26 and door lever 18 in an opposite direction to return the shutter or door 14 to the closed position. In one non-limiting embodiment, the electronic latch 44 may include a cinching function to cinch the door 10 to be fully closed once the door 10 is positioned into a position where the latch engages a striker secured to a pillar or structural member of the vehicle.

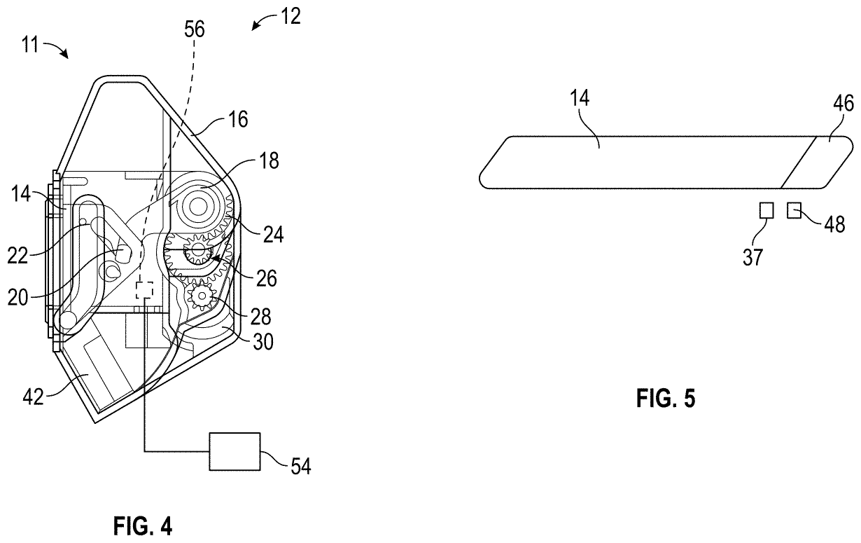

The housing 16 of the vehicle door handle assembly 12 allows the same to be secured to vehicle doors 10 of multiple configurations as the housing 16 is angled inwardly with respect to an outer shell 11 of the vehicle door 10. See at least FIG. 4

Referring now to at least FIG. 5, the vehicle door handle assembly 12 also includes a locking function. It being understood that operation of locking is possible only if the ID is valid. The lock/unlock switch 48 may in one embodiment be a capacitive sensor which is activated when a user touches or is in close contact with the lock/unlock interface portion 46. Alternatively, the lock/unlock switch 48 may be actuated by depressing the lock/unlock interface portion 46 such the lock/unlock switch 48.

Referring to at least FIG. 5, the vehicle door handle assembly 12 and especially the shutter actuation switch provides the unlock function. It being understood that operation of unlocking is possible only if the ID is valid. It being understood that operation of the vehicle door handle assembly 12 as described above (e.g., pushing in of the shutter or door 14) could be achieved when the vehicle door handle assembly 12 is locked or unlocked.

The locking and unlocking of the vehicle door 10 handle assembly 12 can also be achieved using near field communication wherein a user (e.g., car sharing) or owner of the vehicle has a key fob or mobile device (e.g., cell phone) that communicates wirelessly with the vehicle door handle assembly 12 such that an appropriate identifier is transmitted from the key fob or mobile device to a receiver of the vehicle door handle assembly 12 and thereafter the user by touching the sensor 42 of the vehicle door handle assembly 12 will unlatch the electronic latch 44 and release the door.

In another embodiment, the vehicle door handle assembly 12 may be configured to automatically open the shutter or door 14 when the key fob or mobile device (e.g., cell phone) communicates wirelessly with the vehicle door handle assembly 12 when it is in close proximity with the vehicle door handle assembly 12 such that an appropriate identifier is transmitted from the key fob or mobile device to a receiver of the vehicle door handle assembly 12. In this embodiment, the shutter or door 14 automatically opens through operation of the motor 30, gear train 26 and door lever 18 and the vehicle door handle assembly 12 is either unlocked automatically or through touching the sensor 42. Thus, the user can then simply touch sensor 42 and open the door 10. In one non-limiting embodiment, sensor 42 may be a capacitive sensor or any other equivalent device that when actuated provides a signal to the latch 44.

Still further and in the aforementioned embodiment and if the user walks away from the vehicle door handle assembly 12, the vehicle door handle assembly 12 can return the shutter or door 14 to the closed position and lock the vehicle.

If an unauthorized user start to push on the shutter 14, the shutter 14 will not move automatically in. However, if the unauthorized user continues to push, he will move the shutter 14 in manually but the vehicle door will not release, even if the unauthorized user touches the sensor or pulls on the mechanical back up since the vehicle door handle assembly 12 will not be in an unlocked state and the latch will not be released.

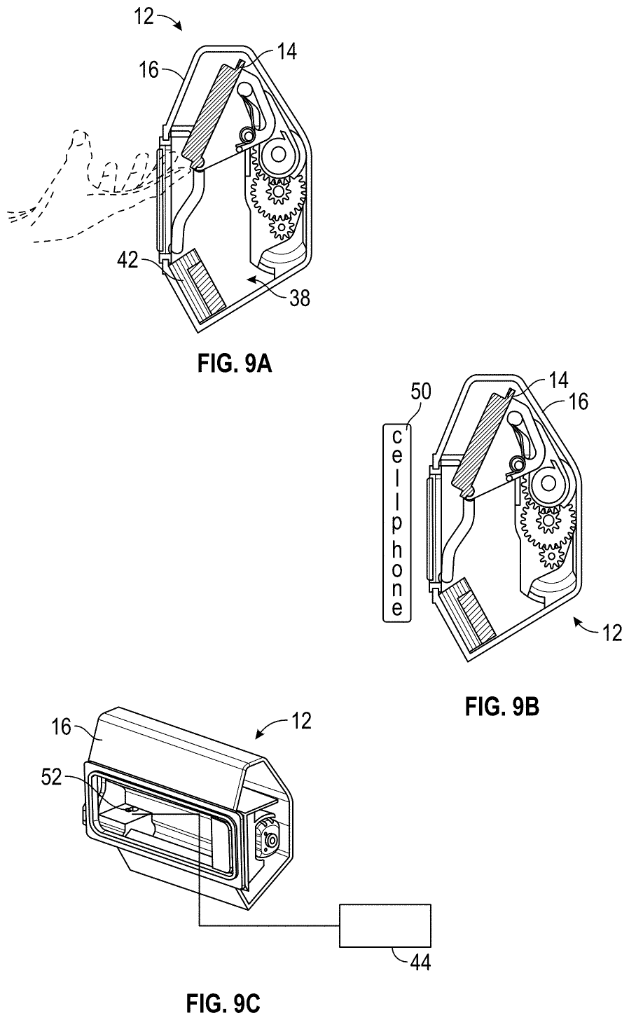

Referring now to at least FIGS. 8A-9C, a manual operation of the vehicle door handle assembly 12 is illustrated. This manual operation may be required due to an operational failure (e.g., dead battery or crash of the vehicle). Here the shutter or door 14 is moved manually from the closed position to the open position by moving the shutter or door 14 upward. In this mode, the motor 30 will not be activated however, the shutter or door 14 is still capable of being moved in. Thereafter and as illustrated in FIG. 8B, an identity of the user is confirmed through insertion of a cell phone or mobile device 50 into opening 40 or presentation of the cell phone or mobile devise closed to the shutter (FIGS. 9A-9C) such that communication with sensor 42 with the cell phone 50 can be achieved. Once the cell phone 50 is inserted into opening 40 or presented to the shutter the cell phone 50 uses near field communication (NFC). Near field communication (NFC) enables devices within a few centimeters of each other to exchange information wirelessly. As such, the near field communication (NFC) between the key fob or cell phone will allow the exchange of recognition code to unlock the latch 44 and the vehicle door handle assembly 12 and re-engage the mechanical backup. In this situation, the latch 44 is equipped with an emergency locking device disengaging the mechanical backup. In order to open the latch 44 during this manual operation, a mechanical release 52 is accessible so that the latch 44 can be opened. In this embodiment, the mechanical release 52 is operatively coupled to latch 44 via linkage such that once the mechanical release 52 is actuated the latch 44 is opened.

In yet another embodiment due to exceptional situation (e.g., crash of the vehicle) the vehicle door handle assembly 12 is operably coupled to other sensors 54 of the vehicle which are used for determining whether a crash is about to occur (e.g., accelerometers etc., configured to detect adverse vehicle conditions). In this embodiment, the sensors 54 when detecting an adverse event (e.g., precursors to a vehicle accident) the sensors 54 may provide a signal to a microcontroller or other equivalent device 56 of the vehicle door handle assembly 12. The microcontroller or other equivalent device 56 is operable couple to the motor 30 in order to move the shutter or door 14 from the closed position to the open position such that the interior cavity 38 and the mechanical release 52 is accessible from the exterior of the vehicle by for example a person responding to the vehicle accident. During this operation, the vehicle door handle assembly 12 will be placed in an unlocked state so that the mechanical release can be actuated by rescue personnel. In addition and by locating the shutter or door 14 into the housing 16 prior the crash event the shutter or door 14 is prevented from being damaged.

In yet another embodiment and during an urgent braking event, the shutter or door 14 will automatically move in, to give free access to the release sensor 42, which in this embodiment will allow the latch 44 to open when the release sensor is touched by an individual's hand or fingers.

In addition, the microcontroller or other equivalent device 56 is also operably coupled to sensors 37, 38 and 42 in order to provide the aforementioned operations of the vehicle door handle assembly 12.

Thus, the vehicle door handle assembly 12 is capable of various operating functions such as but not limited to the following: 1) push and release operation where the user pushes the shutter or door 14 inward and then the motor 30 moves the shutter or door 14 upward and then the user's hand contacts sensor 42 which opens the latch 44; 2) an approach operation where the shutter or door 14 automatically moves inward and then upward due to operation of the motor 30 which is activated when a user with a key fob or mobile phone is in close proximity to the door handle assembly 12, once the shutter or door 14 is moved upward then the user's hand contacts sensor 42 which opens the latch 44 conversely, the shutter or door 14 automatically moves downward and outward due to operation of the motor 30 in an opposite direction which is activated when a user with a key fob or mobile phone is no longer in close proximity to the door handle assembly 12; 3) a manual mode where the shutter or door 14 is manually moved upward and a device recognition is used to unlock the vehicle door handle assembly 12 so that the mechanical release 52 can be operated; and 4) an accident mode where the shutter or door 14 is automatically moved upward in response to signals received from vehicle sensors (e.g., accelerometers) that indicate a predetermined threshold event (e.g., massive deceleration) has occurred and the vehicle door handle assembly 12 is unlocked so that the mechanical release 52 can be operated.

The term “about” is intended to include the degree of error associated with measurement of the particular quantity based upon the equipment available at the time of filing the application. For example, “about” can include a range of ±8% or 5%, or 2% of a given value.

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

While the present disclosure has been described with reference to an exemplary embodiment or embodiments, it will be understood by those skilled in the art that various changes may be made and equivalents may be substituted for elements thereof without departing from the scope of the present disclosure. In addition, many modifications may be made to adapt a particular situation or material to the teachings of the present disclosure without departing from the essential scope thereof. Therefore, it is intended that the present disclosure not be limited to the particular embodiment disclosed as the best mode contemplated for carrying out this present disclosure, but that the present disclosure will include all embodiments falling within the scope of the claims.

1. A door handle assembly for a vehicle door, comprising:
a housing;
a door moveably secured to the housing for movement between a closed position and an open position, the door providing access to an interior cavity of the housing when the door is in the open position, wherein the door moves inwardly and upwardly into the housing in order to transition from the closed position to the open position, the interior cavity being inaccessible and covered by the door when the door is in the closed position.

2. The door handle assembly as in claim 1, wherein the door is operatively coupled to a door lever, the door lever being pivotally secured to a portion of the housing and has a protrusion slidably received within an elongated opening of the door.

3. The door handle assembly as in claim 2, wherein the door lever has a plurality of teeth that meshingly engage a gear train that is operably coupled to a gear that is driven by a motor.

4. The door handle assembly as in claim 1, wherein the door has a pair of protrusions that are slidably received in elongated slots of the housing as the door moves from the closed position to the open position and vice versa.

5. The door handle assembly as in claim 1, further comprising a sensor located within the interior cavity, the sensor being operably coupled to a latch such that upon activation of the sensor the latch is opened.

6. The door handle assembly as in claim 5, wherein the latch is an electronic latch associated with the vehicle door.

7. The door handle assembly as in claim 5, wherein the sensor is a capacitive sensor.

8. The door handle assembly as in claim 1, further comprising a motor for moving the door between the closed position and the open position, the motor being activated when a shutter activation and unlock switch of the door handle assembly is actuated through contact of a portion of the door when it is pivoted inwardly into the housing.

9. The door handle assembly as in claim 1, wherein the housing is angled inwardly with respect to an outer shell of the vehicle door.

10. The door handle assembly as in claim 1, further comprising a lock switch which when actuated locks the vehicle door.

11. The door handle assembly as in claim 10, wherein the lock switch is a capacitive sensor or any other switch technology.

12. The door handle assembly as in claim 1, further comprising a mechanical release located in the interior cavity, the mechanical release operatively coupled to a latch via linkage such that once the mechanical release is actuated the latch is opened.

13. The door handle assembly as in claim 1, wherein the vehicle door handle assembly is operably coupled to sensors of a vehicle which are used for determining whether a crash is about to occur.

14. The door handle assembly as in claim 13, wherein the sensors provide a signal to a microcontroller of the vehicle door handle assembly.

15. A method for operating a door handle assembly of a vehicle door, comprising:
moveably mounting a door to a housing of the door handle assembly, the door capable of movement between a closed position and an open position, the door providing access to an interior cavity of the housing when the door is in the open position, wherein the door moves inwardly and upwardly into the housing in order to transition from the closed position to the open position, the interior cavity being inaccessible and covered by the door when the door is in the closed position.

16. The method as in claim 15, wherein the door is operatively coupled to a door lever, the door lever being pivotally secured to a portion of the housing and has a protrusion slidably received within an elongated opening of the door.

17. The method as in claim 16, wherein the door lever has a plurality of teeth that meshingly engage a gear train that is operably coupled to a gear that is driven by a motor.

18. The method as in claim 15, wherein the door has a pair of protrusions that are slidably received in elongated slots of the housing as the door moves from the closed position to the open position and vice versa.

19. The method as in claim 15, further comprising a sensor located within the interior cavity, the sensor being operably coupled to a latch such that upon activation of the sensor the latch is opened.

20. The method as in claim 19, wherein the latch is an electronic latch associated with the vehicle door.
